(19) United States
(12) Patent Application Publication
(10) Pub. No.: US 2023/0267357 A1
(43) Pub. Date: Aug. 24, 2023

(54) SIMULATION METHOD OF QUANTUM SYSTEM, COMPUTING DEVICE AND STORAGE MEDIUM

(71) Applicant: Beijing Baidu Netcom Science Technology Co., Ltd., Beijing (CN)

(72) Inventors: Xin WANG, Beijing (CN); Xuanqiang ZHAO, Beijing (CN); Zhan YU, Beijing (CN)

(21) Appl. No.: 17/902,311

(22) Filed: Sep. 2, 2022

(30) Foreign Application Priority Data
Feb. 24, 2022 (CN) 202210184325.4

(51) Int. Cl. G06N 10/20

(52) U.S. Cl. CPC G06N 10/20

(57) ABSTRACT

Provided are a simulation method of a quantum system, a computing device, and a storage medium relating to the field of data processing, and in particular to the field of quantum computing. The method includes: acquiring at least two measurement results; calculating a loss value of a loss function representing an average trace distance; and taking, in the case where the loss value of the loss function satisfies an iteration requirement, a preset parameterized quantum circuit with an adjustable parameter at a first parameter value as a target parameterized quantum circuit.

### CROSS-REFERENCE TO RELATED APPLICATIONS

The present application claims priority to Chinese Patent Application No. CN202210184325.4, filed with the China National Intellectual Property Administration on Feb. 24, 2022, the disclosure of which is hereby incorporated herein by reference in its entirety.

### TECHNICAL FIELD

The present disclosure relates to the field of data processing technologies, and in particular, to the field of quantum computing.

### BACKGROUND

At present, quantum computers are developing in scale and practicality. More and more quantum algorithms and applications are emerging, showing a great potential for quantum computers to surpass classical computers.

An important focus of the development of quantum computing is quantum simulation, which simulates a dynamic evolution of a chemical molecular equivalent subsystem, having important applications in quantum chemistry, material science, and other fields.

### SUMMARY

The present disclosure provides a simulation method of a quantum system, computing device, apparatus, and storage medium.

According to one aspect of the present disclosure, there is provided a simulation method of a quantum system, applied to a classical computing device, including: acquiring at least two measurement results, where a first measurement result of the at least two measurement results represents a trace distance between a first output state and a first target output state; a second measurement result of the at least two measurement results represents a trace distance between a second output state and a second target output state; the first output state is an output state after a preset parameterized quantum circuit acts on a first quantum state in the case where an adjustable parameter of the preset parameterized quantum circuit is at a first parameter value; the second output state is an output state after the preset parameterized quantum circuit acts on a second quantum state in the case where the adjustable parameter of the preset parameterized quantum circuit is at the first parameter value; the first target output state represents an output state after an initial time evolution circuit acts on the first quantum state; the second target output state represents an output state after the initial time evolution circuit acts on the second quantum state; the initial time evolution circuit is an approximate quantum circuit of a unitary matrix of a target quantum system containing n quantum bits; the preset parameterized quantum circuit is a quantum circuit containing n quantum bits and having the adjustable parameter; and n is a natural number greater than or equal to 1; calculating a loss value of a loss function representing an average trace distance, based on trace distances represented by the at least two measurement results; and taking the preset parameterized quantum circuit with the adjustable parameter at the first parameter value as a target parameterized quantum circuit, in the case where the loss value of the loss function satisfies an iteration requirement, where the target parameterized quantum circuit is the approximate quantum circuit of the initial time evolution circuit.

According to another aspect of the present disclosure, there is provided a simulation method of a quantum system, applied to a quantum computing device, including: applying a preset parameterized quantum circuit to at least a first quantum state to obtain a first output state in the case where an adjustable parameter of the preset parameterized quantum circuit is at a first parameter value, and applying the preset parameterized quantum circuit to at least a second quantum state to obtain a second output state in the case where the adjustable parameter of the preset parameterized quantum circuit is at the first parameter value; acquiring at least two measurement results, where a first measurement result of the at least two measurement results represents a trace distance between the first output state and a first target output state; a second measurement result of the at least two measurement results represents a trace distance between the second output state and a second target output state; the first target output state represents an output state after an initial time evolution circuit acts on the first quantum state; the second target output state represents an output state after the initial time evolution circuit acts on the second quantum state; the initial time evolution circuit is an approximate quantum circuit of a unitary matrix of a target quantum system containing n quantum bits; the preset parameterized quantum circuit is a quantum circuit containing n quantum bits and having the adjustable parameter, and n is a natural number greater than or equal to 1; and sending the at least two measurement results.

According to another aspect of the present disclosure, there is provided a classical computing device, including: a data acquisition unit, configured to acquire at least two measurement results, where a first measurement result of the at least two measurement results represents a trace distance between a first output state and a first target output state; a second measurement result of the at least two measurement results represents a trace distance between a second output state and a second target output state; the first output state is an output state after a preset parameterized quantum circuit acts on a first quantum state in the case where an adjustable parameter of the preset parameterized quantum circuit is at a first parameter value; the second output state is an output state after the preset parameterized quantum circuit acts on a second quantum state in the case where the adjustable parameter of the preset parameterized quantum circuit is at the first parameter value; the first target output state represents an output state after an initial time evolution circuit acts on the first quantum state; the second target output state represents an output state after the initial time evolution circuit acts on the second quantum state; the initial time evolution circuit is an approximate quantum circuit of a unitary matrix of a target quantum system containing n quantum bits; the preset parameterized quantum circuit is a quantum circuit containing n quantum bits and having the adjustable parameter; and n is a natural number greater than or equal to 1; and a data processing unit, configured to calculate a loss value of a loss function representing an average trace distance, based on trace distances represented by the at least two measurement results; and take the preset parameterized quantum circuit with the adjustable parameter at the first parameter value as a target parameterized quantum circuit, in the case where the loss value of the loss function satisfies an iteration requirement, where the target parameterized quantum circuit is the approximate quantum circuit of the initial time evolution circuit.

According to another aspect of the present disclosure, there is provided a quantum computing device, including: a quantum processing unit, configured to apply a preset parameterized quantum circuit to at least a first quantum state to obtain a first output state in the case where an adjustable parameter of the preset parameterized quantum circuit is at a first parameter value; and apply the preset parameterized quantum circuit to at least a second quantum state to obtain a second output state in the case where the adjustable parameter of the preset parameterized quantum circuit is at the first parameter value; a measurement unit, configured to acquire at least two measurement results, where a first measurement result of the at least two measurement results represents a trace distance between the first output state and a first target output state; a second measurement result of the at least two measurement results represents a trace distance between the second output state and a second target output state; the first target output state represents an output state after an initial time evolution circuit acts on the first quantum state; the second target output state represents an output state after the initial time evolution circuit acts on the second quantum state; the initial time evolution circuit is an approximate quantum circuit of a unitary matrix of a target quantum system containing n quantum bits, the preset parameterized quantum circuit is a quantum circuit containing n quantum bits and having the adjustable parameter; and n is a natural number greater than or equal to 1; and a communication unit, configured to send the at least two measurement results.

According to another aspect of the present disclosure, there is provided a classical computing device. The classical computing device includes: at least one processor; and a memory connected in communication with the at least one processor, where the memory stores an instruction executable by the at least one processor, and the instruction, when executed by the at least one processor, enables the at least one processor to execute the method applied to the classical computing device as described above.

According to another aspect of the present disclosure, there is provided a quantum computing device. The quantum computing device including: at least one quantum processing unit (QPU); a memory coupled to the at least one QPU and configured to store an executable instruction, where the instruction is executed by the at least one quantum processing unit to enable the at least one quantum processing unit to execute the method applied to the quantum computing device as described above.

According to another aspect of the present disclosure, there is provided a computing apparatus, including: the classical computing device as described above and the quantum computing device as described above.

According to another aspect of the present disclosure, there is provided a non-transitory computer-readable storage medium on which a computer instruction is stored, and the computer instruction is used to cause a computer to execute the method applied to the classical computing device as described above.

According to another aspect of the present disclosure, there is provided a non-transitory computer-readable storage medium on which a computer instruction is stored, and the computer instruction, when executed by at least one quantum processing unit, causes the at least one quantum processing unit to execute the method applied to the quantum computing device as described above.

According to another aspect of the present disclosure, there is provided a computer program product including a computer program. The computer program when executed by a processor, implements the method applied to the classical computing device as described above; alternatively, the computer program, when executed by at least one quantum processing unit, implements the method applied to the quantum computing device as described above.

In this way, the approximate quantum circuit of the unitary matrix of the target quantum system can be simplified, and the cost of quantum simulation on the state-of-the-art quantum computing equipment can be greatly reduced.

It should be understood that the contents described in this section is not intended to identify key or important features of embodiments of the present disclosure, nor is it used to limit the scope of the present disclosure. Other features of the present disclosure will be readily understood throughout the description below.

### BRIEF DESCRIPTION OF THE DRAWINGS

The accompanying drawings are provided to better understand the present solution, and do not constitute a limitation to the present disclosure.

FIG. 1 is a schematic diagram of an implementation flow of a simulation method applied to a quantum system in a classical computing device according to embodiments of the present disclosure.

FIG. 2 is a structural diagram of a preset parameterized quantum circuit in a specific example of a simulation method of a quantum system according to embodiments of the present disclosure.

FIG. 3 is a schematic diagram of an implementation flow of a simulation method applied to a quantum system in a quantum computing device according to embodiments of the present disclosure.

FIG. 4 is a schematic diagram of the implementation flow of a simulation method of a quantum system according to embodiment of the present disclosure in one specific example.

FIG. 5 is a structural diagram of a preset parameterized quantum circuit in one specific example of a simulation method of a quantum system according to embodiments of the present disclosure.

FIG. 6 is a structural diagram of a classical computing device according to embodiments of the present disclosure.

FIG. 7 is a structural diagram of a quantum computing device according to embodiments of the present disclosure.

FIG. 8 is a structural diagram of a computing apparatus according to embodiments of the present disclosure.

FIG. 9 is a block diagram of a classical electronic apparatus for implementing a simulation method of a quantum system according to embodiments of the present disclosure.

### DETAILED DESCRIPTION

Hereinafter, descriptions of exemplary embodiments of the present disclosure will be provided in conjunction with the accompanying drawings. Various details of the embodiments of the present disclosure are included for the understanding purpose and should be considered as merely exemplary. Therefore, those of ordinary skill in the art should realize that various changes and modifications can be made to the embodiments described herein without departing from the scope and spirit of the present disclosure. Likewise, for clarity and conciseness, descriptions of well-known functions and structures are omitted in the following description.

Efficient and practical quantum simulation has a good application prospect in the research and development of new drugs and batteries with quantum chemistry. The reason is that the quantum simulation can be used to simulate the evolution of a quantum system in the micro world, to help a researcher develop a new material and simulate a chemical molecular property, for example.

Moreover, quantum simulation is also a core sub-step of several common quantum algorithms in quantum machine learning, such as quantum principal component analysis and quantum algorithm for linear systems of equations, and the like.

Quantum simulation will be further described in detail below; specifically, the evolution of a quantum system over time is determined by Hamiltonian of the quantum system. Specifically, for a quantum system the evolution of which is determined by a certain Hamiltonian H, its quantum state at time t is: |ψ(t) [symbol] =e^{-iHt}|ψ(0) [symbol] .

Herein, |ψ(0) [symbol] represents an initial state of the quantum system (i.e., an initial quantum state), i=\sqrt{−1} is an imaginary number, and U=e^{-iHt} is an evolved unitary matrix. The goal of quantum simulation is to design a quantum circuit to realize the unitary matrix U=e^{-iHt}, and then prepare a target state |ψ(t) [symbol] (i.e., a target quantum state) of the quantum system at time t on a quantum computing equipment with a certain accuracy.

The main technical problem to be solved by the scheme of the present disclosure is how to design a simplified quantum circuit approximating the unitary matrix U=e^{-iHt}, that is, to design a target time evolution circuit, given a Hamiltonian H and an evolution time t.

In a practical application, because the short-term and medium-term quantum computing device can achieve a small quantity of quantum bits, are greatly affected by noise and has a limited accuracy, how to use fewer quantum bits and basic quantum gates to achieve the same accuracy of quantum simulation has become an important problem of the quantum algorithm in the near future.

Based on this, a scheme of the present disclosure provides a parameterized quantum circuits that can make full use of the quantum computing device in the state of art, and based on any quantum simulation schemes (i.e., preset algorithms), the parameterized quantum circuit is creatively trained to obtain a simpler target time evolution circuit with fewer quantum gates. As such, the cost of realizing quantum simulation on the quantum computing devices in the state of art can be greatly reduced. Moreover, the training process of the disclosed scheme is simple and efficient.

Specifically, a scheme of the present disclosure provides a simulation method for a quantum system, which is applied to a classical computing device. As shown in FIG. 1, the method includes the followings.

In S101, at least two measurement results are acquired by the classical computing device. A first measurement result of the at least two measurement results represents a trace distance between a first output state and a first target output state; a second measurement result of the at least two measurement results represents a trace distance between a second output state and a second target output state; the first output state is an output state after a preset parameterized quantum circuit acts on a first quantum state in the case where an adjustable parameter of the preset parameterized quantum circuit is at a first parameter value; the second output state is an output state after the preset parameterized quantum circuit acts on a second quantum state in the case where the adjustable parameter of the preset parameterized quantum circuit is at the first parameter value; the first target output state represents an output state after an initial time evolution circuit acts on the first quantum state; the second target output state represents an output state after the initial time evolution circuit acts on the second quantum state; the initial time evolution circuit is an approximate quantum circuit of a unitary matrix of a target quantum system containing n quantum bits; the preset parameterized quantum circuit is a quantum circuit containing n quantum bits and having the adjustable parameter; and n is a natural number greater than or equal to 1.

It can be understood that the initial time evolution circuit described in the scheme of the present disclosure is an approximate quantum circuit of the unitary matrix of the target quantum system, and the preset parameterized quantum circuit is any quantum circuit containing the adjustable parameter. As such, a simplified circuit of the initial time evolution circuit is obtained by training the preset parameterized quantum circuit, so as to minimize the cost of realizing quantum simulation.

Here, the first parameter value may be a parameter value at the time of initialization or a parameter value adjusted in the previous iteration process, which is not limited by the present disclosure.

It can be understood that the adjustable parameter described in the scheme of the present disclosure may be one or more parameters, which is not limited by the present disclosure, as long as the approximate quantum circuit of the initial time evolution circuit may be obtained based on the training of the preset parameterized quantum circuit. Accordingly, when there are two or more adjustable parameters, the first parameter value and a second parameter value, which will be described later, are not a specific value, but refer to a parameter value corresponding to a relevant parameter, such as, a group of parameter values corresponding to a group of parameters.

In S102, a loss value of a loss function representing an average trace distance is calculated, based on trace distances represented by the at least two measurement results, by the classical computing device.

In S103, the preset parameterized quantum circuit with the adjustable parameter at the first parameter value is taken by the classical computing device as a target parameterized quantum circuit, in the case where the loss value of the loss function satisfies an iteration requirement. The target parameterized quantum circuit is the approximate quantum circuit of the initial time evolution circuit.

In this way, the scheme of the present disclosure simplifies the approximate quantum circuit of the unitary matrix of the target quantum system and designs a quantum circuit having a relatively high simulation accuracy on the short-term and medium-term quantum computing device, thereby greatly reducing the cost of quantum simulation on the state-of-the-art quantum computing devices and improving the possibility of realizing practical quantum simulation applications on the state-of-the-art quantum devices with both practicality and efficiency.

For example, the preset parameterized quantum circuit may mainly include several single-qubit revolving gates and controlled reversal gates. A rotation angle of the single-qubit revolving gate is the adjustable parameter in the preset parameterized quantum circuit.

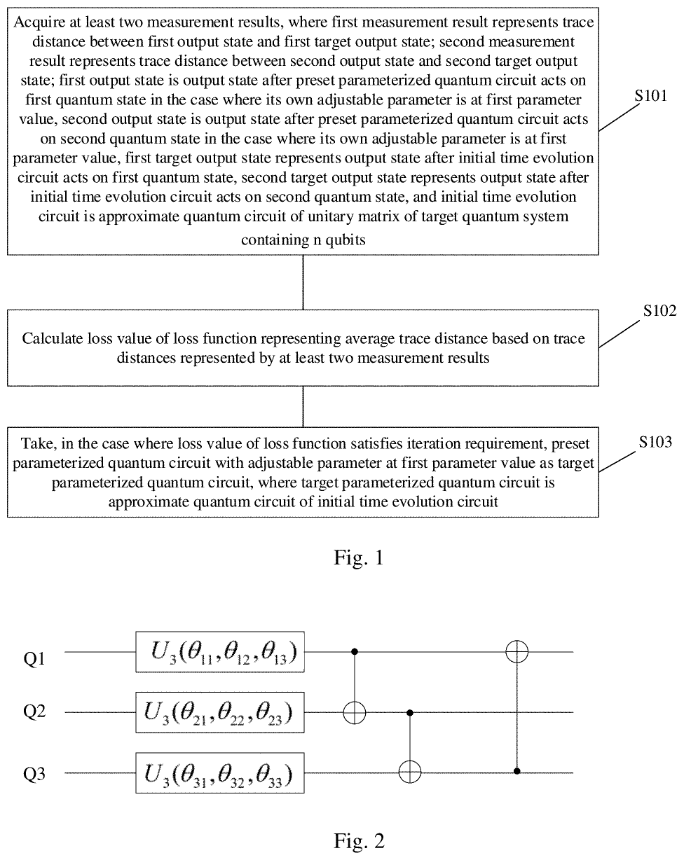

Specifically, as shown in FIG. 2, for a quantum system with three qubits, the selected parameterized quantum circuit to be trained (i.e., the preset parameterized quantum circuit) further includes three qubits, which are: qubit Q1, qubit Q2 and qubit Q3; furthermore, each qubit acts on a single-qubit revolving gate U₃; for example, the revolving gate U₃ (i.e., a generalized rotation operation on the Bloch sphere, such as a rotation operation on the X-axis, Y-axis or Z-axis) contains three adjustable parameters. Specifically, for the single-qubit revolving gate U₃ acting on qubit Q1, the three adjustable parameters may be recorded as θ₁₁, θ₁₂ and θ₁₃, that is, the single-qubit revolving gate U₃ acting on qubit Q1 may be recorded as U₃ (θ₁₁, θ₁₂, θ₁₃); similarly, the single-qubit revolving gate U₃ acting on qubit Q2 may be recorded as U₃ (θ₂₁, θ₂₂, θ₂₃), and the single-qubit revolving gate U₃ acting on qubit Q3 may be recorded as U₃ (θ₃₁, θ₃₂, θ₃₃). Further, a CNOT gate acts between qubit Q1 and qubit Q2, a CNOT gate acts between qubit Q2 and qubit Q3, and a CNOT gate acts between qubit Q1 and qubit Q3. In other words, there are three CNOT gates in total.

It can be understood that the preset parameterized quantum circuit as set forth above is only exemplary and is not intended to limit the scheme of the present disclosure. In a practical application, the parameterized quantum circuit having other structures may also be trained, which is not limited by the scheme of the present disclosure.

In a specific example according to the scheme of the present disclosure, a quantity of quantum gates in the preset parameterized quantum circuit is less than a quantity of quantum gates in the initial time evolution circuit. That is, in the scheme of the present disclosure, the target parameterized quantum circuit containing as few quantum gates as possible may be used as the approximate quantum circuit of the initial time evolution circuit, thereby laying a foundation for further simplifying the initial time evolution circuit and reducing the cost of quantum simulation.

Moreover, according to the scheme of the present disclosure, the approximate quantum circuit of the initial time evolution circuit may be obtained without using an auxiliary quantum bit. Therefore, compared with the existing schemes that need to use the auxiliary quantum bit, the scheme of the present disclosure uses as few quantum bits as possible, thereby further reducing the cost of quantum simulation.

In a specific example according to the scheme of the present disclosure, the initial time evolution circuit may be obtained based on the following method, which specifically includes: obtaining, by the classical computing device, at least a target Hamiltonian and a time parameter of the target quantum system to be simulated; and processing the target Hamiltonian and the time parameter of the target quantum system based on a preset algorithm, to obtain the initial time evolution circuit that simulates the unitary matrix of the target quantum system and contains at least the time parameter. In other words, the specific example specifically clarifies the relevant information on which the acquisition of the initial time evolution circuit depends, whereby simulating and acquiring the initial time evolution circuit in the classical computing device, and the acquired initial time evolution circuit being an approximate quantum circuit of the unitary matrix of the target quantum system, which lays a foundation for simplifying the initial time evolution circuit and reducing the cost of quantum simulation.

Herein, it can be understood that the preset algorithm described above may be any quantum simulation algorithm, which is not limited by the present disclosure.

It should be noted that in the specific example, the initial time evolution circuit is obtained based on the target Hamiltonian, time parameter and preset algorithm of the target quantum system; however, in a practical application, the initial time evolution circuit may also be directly input by a user, that is, the initial time evolution circuit corresponding to the target quantum system specified by the user is directly obtained by the classical computing device. As such, the initial time evolution circuit specified by the user is simplified. In this way, various demands of the user can be fulfilled such that the practicability of the scheme of the present disclosure is further improved.

It can be understood that, in the example, the preset algorithm may be built in the classic computing device or selected by the classic computing device based on the current computing resources, which is not limited by the present disclosure.

In a specific example according to the scheme of the present disclosure, the initial time evolution circuit may also be obtained in the following manner. Specifically, the classical computing device acquires the preset algorithm (such as the preset algorithm input by the user) and a parameter set of the preset algorithm. Based on this, the above-mentioned operation of processing the target Hamiltonian and the time parameter of the target quantum system based on the preset algorithm to obtain the initial time evolution circuit that simulates the unitary matrix of the target quantum system and contains at least the time parameter, specifically includes: operating the preset algorithm, based on the target Hamiltonian, the time parameter and the parameter set, to obtain the initial time evolution circuit that simulates the unitary matrix of the target quantum system and contains at least the time parameter. Thus, a foundation can be laid for simplifying the initial time evolution circuit and reducing the cost of quantum simulation.

It can be understood that, in this example, the preset algorithm may be input by the user, such that the demands of the user can be further fulfilled and various demands for scientific research can also be fulfilled while reducing the cost of quantum simulation.

In a specific example according to the present disclosure, the first quantum state and the second quantum state satisfy the following requirement: in the case where the first quantum state ρ satisfies V(θ) ρ V^{\} (θ)=UρU^{\} and the second quantum state σ satisfies V(θ) σ V^{\} (θ)=UσU^{†}, U^{†} V(θ)=I is obtained, where U is the initial time evolution circuit, V(θ) is the preset parameterized quantum circuit, and θ is the adjustable parameter.

In this way, a support is provided for training the preset parameterized quantum circuits using input states as few as possible. In other words, in the scheme of the present disclosure, two quantum states at a minimum are used to train the approximate quantum circuit of the initial time evolution circuit (this process can be proved based on mathematical derivation, the description of which will be omitted herein). Therefore, compared with the existing schemes, the scheme of the present disclosure has great advantages in terms of efficiency and cost consumption. For example, in the case where n is relatively large, the scheme of the present disclosure can effectively reduce the consumption of preparing and storing quantum states, while reducing the time required to train the preset parameterized quantum circuit. In addition, the scheme of the present disclosure can use less data to calculate the loss function, which means that the scheme of the present disclosure has smaller error, higher accuracy and stronger practicability.

In a specific example according to the present disclosure, the first quantum state is a mixed quantum state; and/or the second quantum state is a mixed quantum state. For example, in an example, both of the first quantum state and the second quantum state are a randomly generated mixed quantum state, which provides data support for simplifying the initial time evolution circuit.

Herein, the quantum state (i.e., the first quantum state and the second quantum state) as stated in the present disclosure will be briefly described; specifically, in quantum mechanics, a quantum state may be represented by a density matrix and may be classified into a pure state and a mixed state. In order to distinguish from the specific examples of the present disclosure, the pure state may be recorded here as pp, and the mixed state is recorded as ρm; it is understandable that the mixed state described in the present disclosure satisfies the following requirement; specifically,

The density matrix of pure state ρₚ may be expressed as ρₚ=|ψ [symbol] ψ|, and the mixed state ρₘ may be expressed as ensembles of more than two pure states. That is, the density matrix of the mixed state ρₘ may be expressed as: ρₘ=Σi cᵢ|ψᵢ [symbol] ψᵢ|, where Σᵢ cᵢ=1.

In a specific example according to the present disclosure, in the case where the loss value of the loss function does not satisfies the iteration requirement (e.g., not converged, or a quantity of iterations being less than a preset number), the classical computing device adjusts the first parameter value of the adjustable parameter to a second parameter value, and sends the second parameter value of the adjustable parameter. For example, the parameter is adjusted to the second parameter value through the gradient descent method or other optimization methods, and then the second parameter value of the adjustable parameter is sent to the quantum computing device, so that the quantum computing device may obtain a new measurement result based on the updated parameter value. Thus, the technical support can be provided for realizing the quantum-classical hybrid algorithm and obtaining the approximate quantum circuit of initial time evolution circuit.

In a specific example according to the present disclosure, in the case where the loss value of the loss function does not satisfy the iteration requirement (e.g., not converged, or the quantity of iterations being less than the preset number) and after the second parameter value of the adjustable parameter is sent to the quantum computing device, the classical computing device may further acquire at least two new measurement results. A new first measurement result of the at least two new measurement results represents a new trace distance between a new first output state and the first target output state; a new second measurement result of the at least two new measurement results represents a new trace distance between a new second output state and the second target output state; the new first output state is an output state after the preset parameterized quantum circuit acts on the first quantum state in the case where the adjustable parameter of the preset parameterized quantum circuit is at the second parameter value; and the new second output state is an output state after the preset parameterized quantum circuit acts on the second quantum state in the case where the adjustable parameter of the preset parameterized quantum circuit is at the second parameter value. Further, based on new trace distances represented by the at least two new measurement results, a new loss value of the loss function may be calculated, and the above operation is repeated until a new loss value satisfies the iteration requirement.

In other words, in the present disclosure, the quantum computing device is used to prepare the preset parameterized quantum circuit and obtain the measurement results while the classical computing device is responsible for calculating the loss value and updating the parameters, so as to train the preset parameterized quantum circuit and realize the quantum-classical hybrid algorithm, which provides technical support for obtaining the approximate quantum circuit of the initial time evolution circuit.

In this way, the scheme of the present disclosure simplifies the approximate quantum circuit of the unitary matrix of the target quantum system and designs a quantum circuit having a relatively high simulation accuracy on the short-term and medium-term quantum computing devices, thereby greatly reducing the cost of quantum simulation on the state-of-the-art quantum computing devices and improving the possibility of realizing practical quantum simulation applications on the state-of-the-art quantum devices with both practicality and efficiency.

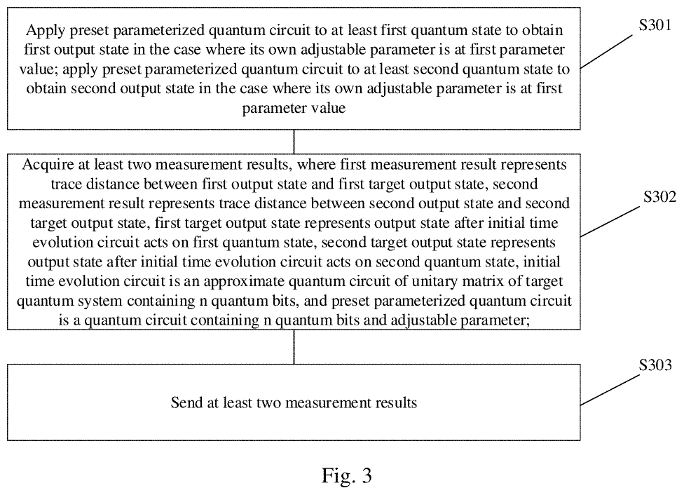

A scheme of the present disclosure further provides a simulation method of a quantum system, which is applied to a quantum computing device. As shown in FIG. 3, the method includes the followings.

In S301, a preset parameterized quantum circuit is applied to at least a first quantum state to obtain a first output state in the case where an adjustable parameter of the preset parameterized quantum circuit is at a first parameter value; and the preset parameterized quantum circuit is applied to at least a second quantum state to obtain a second output state in the case where the adjustable parameter of the preset parameterized quantum circuit is at the first parameter value.

In S302, at least two measurement results are acquired. A first measurement result of the at least two measurement results represents a trace distance between the first output state and a first target output state; a second measurement result of the at least two measurement results represents a trace distance between the second output state and a second target output state; the first target output state represents an output state after an initial time evolution circuit acts on the first quantum state; the second target output state represents an output state after the initial time evolution circuit acts on the second quantum state; the initial time evolution circuit is an approximate quantum circuit of a unitary matrix of a target quantum system containing n quantum bits; the preset parameterized quantum circuit is a quantum circuit containing n quantum bits and having the adjustable parameter; and n is a natural number greater than or equal to 1.

In S303, the at least two measurement results are sent.

It should be noted that the quantum computing device may send a measurement result to the classical computing device right after obtaining the measurement result, or send measurement results to the classical computing device together after obtaining all of them. This is not limited by the scheme of the present disclosure.

Herein, the first parameter value may be a parameter value at the time of initialization or a parameter value adjusted in the previous iteration process, which is not limited by the present disclosure.

It can be understood that the adjustable parameter described in the scheme of the present disclosure may be one or more parameters, which is not limited by the present disclosure, as long as the approximate quantum circuit of the initial time evolution circuit can be obtained based on the training of the preset parameterized quantum circuit. Accordingly, when there are two or more adjustable parameters, the first parameter value and the second parameter value, which will be described later, are not a specific value, but refer to a parameter value corresponding to a relevant parameter, such as, a group of parameter values corresponding to a group of parameters.

In this way, the scheme of the present disclosure, by using two quantum states at a minimum, such as the first quantum state and the second quantum state, can simplify the initial time evolution circuit, reduce the resource cost and time cost of quantum simulation, greatly improve the practicality of quantum simulation, provide technical support for the state-of-the-art quantum devices to operate complex quantum algorithms, and indirectly improve a value of the practical application of the state-of-the-art quantum device.

In the meanwhile, the scheme of the present disclosure simplifies the approximate quantum circuit of the unitary matrix of the target quantum system and designs a quantum circuit having a relatively high simulation accuracy on the short-term and medium-term quantum computing device, thereby greatly reducing the cost of quantum simulation on the state-of-the-art quantum computing devices and improving the possibility of realizing practical quantum simulation applications on the state-of-the-art quantum devices with both practicality and efficiency.

It can be understood that for the preset parameterized quantum circuit, reference can be made to the above examples, the description of which will not be repeated herein. Moreover, in practical application, the parameterized quantum circuits having other structures may be trained, which is not limited by the scheme of the present disclosure.

In a specific example according to the scheme of the present disclosure, a quantity of quantum gates in the preset parameterized quantum circuit is less than a quantity of quantum gates in the initial time evolution circuit. That is, in the scheme of the present disclosure, the target parameterized quantum circuit containing as few quantum gates as possible may be used as the approximate quantum circuit of the initial time evolution circuit, thereby laying a foundation for further simplifying the initial time evolution circuit and reducing the cost of quantum simulation.

Moreover, according to the scheme of the present disclosure, the approximate quantum circuit of the initial time evolution circuit may be obtained without using an auxiliary quantum bit, and thus, compared with the existing schemes that require the use of the auxiliary quantum bit, quantum bits are used as few as possible in the scheme of the present disclosure, which further reduces the cost of quantum simulation.

In a specific example according to the scheme of the present disclosure, the initial time evolution circuit may be obtained based on the following method, which specifically includes: obtaining, by the quantum computing device, at least a target Hamiltonian and a time parameter of the target quantum system to be simulated; processing the target Hamiltonian and the time parameter of the target quantum system based on a preset algorithm, to obtain the initial time evolution circuit that simulates the unitary matrix of the target quantum system and contains at least the time parameter. In other words, the specific example specifically clarifies the relevant information on which the acquisition of the initial time evolution circuit depends, whereby simulating and acquiring the initial time evolution circuit in the classical computing device, and the acquired initial time evolution circuit being an approximate quantum circuit of the unitary matrix of the target quantum system, which lays a foundation for simplifying the initial time evolution circuit and reducing the cost of quantum simulation.

Herein, it can be understood that the preset algorithm described above may be any quantum simulation algorithm, which is not limited by the present disclosure.

It should be noted that in the specific example, the initial time evolution circuit is obtained based on the target Hamiltonian, time parameter and preset algorithm of the target quantum system; however, in a practical application, the initial time evolution circuit may also be directly input by a user, that is, the initial time evolution circuit corresponding to the target quantum system specified by the user and directly obtained by the quantum computing device. As such, the initial time evolution circuit specified by the user is simplified. In this way, various demands of the user can be fulfilled such that the practicability of the scheme of the present disclosure is further improved.

It can be understood that, in the example, the preset algorithm may be built in the classic computing device or selected by the classic computing device based on the current computing resources, which is not limited by the present disclosure.

In a specific example according to the scheme of the present disclosure, the initial time evolution circuit may also be obtained in the following manner. Specifically, the quantum computing device further acquires the preset algorithm and a parameter set of the preset algorithm. The above-mentioned operation of processing the target Hamiltonian and the time parameter of the target quantum system based on the preset algorithm to obtain the initial time evolution circuit that simulates the unitary matrix of the target quantum system and contains at least the time parameter, specifically, includes: operating the preset algorithm, based on the target Hamiltonian, the time parameter and the parameter set, to obtain the initial time evolution circuit that simulates the unitary matrix of the target quantum system and contains at least time parameters. Thus, a foundation can be laid for simplifying the initial time evolution circuit and reducing the cost of quantum simulation.

It can be understood that, in this example, the preset algorithm may be input by the user, such that the demands of the user can be further fulfilled and various demands for scientific research can also be fulfilled while reducing the cost of quantum simulation.

In a specific example according to the present disclosure, the first quantum state and the second quantum state satisfy the following requirement: in the case where the first quantum state ρ satisfies V(θ) ρ V^{†} (θ)=UρU^{†} and the second quantum state σ satisfies V(θ) σ V^{\} (θ)=UσU^{†}, U^{†} V(θ)=I is obtained, where U is the initial time evolution circuit, V(θ) is the preset parameterized quantum circuit, and θ is the adjustable parameter.

In this way, a support is provided for training the preset parameterized quantum circuits using input states as few as possible. In other words, in the scheme of the present disclosure, two quantum states at a minimum are used to train the approximate quantum circuit of the initial time evolution circuit (this process can be proved based on mathematical derivation, the description of which will be omitted herein). Therefore, compared with the existing schemes, the scheme of the present disclosure has great advantages in terms of efficiency and cost consumption. For example, in the case where n is relatively large, the scheme of the present disclosure can effectively reduce the consumption of preparing and storing quantum states, while reducing the time required to train the preset parameterized quantum circuit. In addition, the scheme of the present disclosure can use less data to calculate the loss function, which means that the scheme of the present disclosure has smaller error, higher accuracy and stronger practicability.

In a specific example according to the present disclosure, the first quantum state is a mixed quantum state; and/or the second quantum state is a mixed quantum state. For example, in an example, both of the first quantum state and the second quantum state are a randomly generated mixed quantum state, which provides data support for simplifying the initial time evolution circuit.

In a specific example according to the present disclosure, the quantum computing device further applies the initial time evolution circuit to the first quantum state, to obtain the first target output state; and applies the initial time evolution circuit to the second quantum state, to obtain the second target output state. In this way, the training data set is obtained to provide data support for the approximate circuit of the initial time evolution circuit.

In a specific example according to the present disclosure, the quantum computing device further receives a second parameter value of the adjustable parameter; applies the preset parameterized quantum circuit to at least the first quantum state to obtain a new first output state, in the case where its own adjustable parameter is at the second parameter value, and applies the preset parameterized quantum circuit to at least the second quantum state to obtain a new second output state, in the case where its own adjustable parameter is at the second parameter value; acquires at least two new measurement results, where a new first measurement result of the at least two new measurement results represents a new trace distance between a new first output state and the first target output state, and a new second measurement result of the at least two new measurement results represents a new trace distance between a new second output state and the second target output state; and sends the at least two new measurement results. That is, in the present disclosure, the quantum computing device is used to prepare the preset parameterized quantum circuit and obtain the measurement results, while the classical computing device is responsible for calculating the loss value and updating the parameters, so as to train the preset parameterized quantum circuit and realize the quantum-classical hybrid algorithm, which provides technical support for obtaining the approximate quantum circuit of the initial time evolution circuit.

In this way, the scheme of the present disclosure simplifies the approximate quantum circuit of the unitary matrix of the target quantum system and designs a quantum circuit having a relatively high simulation accuracy on the short-term and medium-term quantum computing device, thereby greatly reducing the cost of quantum simulation on the state-of-the-art quantum computing devices and improving the possibility of realizing practical quantum simulation applications on the state-of-the-art quantum devices with both practicality and efficiency.

The scheme of the present disclosure will be described in detail with reference to specific examples. In the scheme of the present disclosure, two randomly-generated mixed quantum states are creatively used to train the parameterized quantum circuit to simplify the initial time evolution circuit (i.e., the initial quantum circuit) to obtain the simplified quantum circuit of the initial quantum circuit, i.e., the approximate quantum circuit. The training process is simple and efficient.

Specifically, given a Hamiltonian to be simulated, firstly, an initial quantum circuit of the Hamiltonian is simulated based on a product method or other methods. Secondly, the initial quantum circuit is simplified by training a parameterized quantum circuit, to obtain an approximate quantum circuit of the initial quantum circuit, so as to reduce the cost of simulating the Hamiltonian. For example, the quantity of quantum gates in the target time evolution circuit (i.e., the initial quantum circuit) is reduced.

In the example, the parameterized quantum circuit mainly includes several single-qubit revolving gates and controlled reversal gates. A rotation angle of the single-qubit revolving gate is the adjustable parameter in the parameterized quantum circuit. Specifically, as shown in FIG. 2, for a quantum system with three qubits, the selected parameterized quantum circuit to be trained (i.e., the preset parameterized quantum circuit) also includes three qubits, which are: qubit Q1, qubit Q2 and qubit Q3; furthermore, each qubit acts on a single-qubit revolving gate U₃; for example, the revolving gate U₃ (i.e., a generalized rotation operation on the Bloch sphere, such as a rotation operation on the X-axis, Y-axis or Z-axis) contains three adjustable parameters. Specifically, for the single-qubit revolving gate U₃ acting on qubit Q1, the three adjustable parameters may be recorded as θ₁₁, θ₁₂ and θ₁₃, that is, the single-qubit revolving gate U₃ acting on qubit Q1 may be recorded as U₃ (θ₁₁, θ₁₂, θ₁₃); similarly, the single-qubit revolving gate U₃ acting on qubit Q2 may be recorded as U₃ (θ₂₁, θ₂₂, θ₂₃), and the single-qubit revolving gate U₃ acting on qubit Q3 may be recorded as U₃ (θ₃₁, θ₃₂, θ₃₃). Further, a CNOT gate acts between qubit Q1 and qubit Q2, a CNOT gate acts between qubit Q2 and qubit Q3, and a CNOT gate acts between qubit Q1 and qubit Q3. In other words, there are three CNOT gates in total.

It can be understood that the preset parameterized quantum circuit as set forth above is only exemplary and is not intended to limit the scheme of the present disclosure. In a practical application, the parameterized quantum circuit having other structures may further be trained, which is not limited by the scheme of the present disclosure.

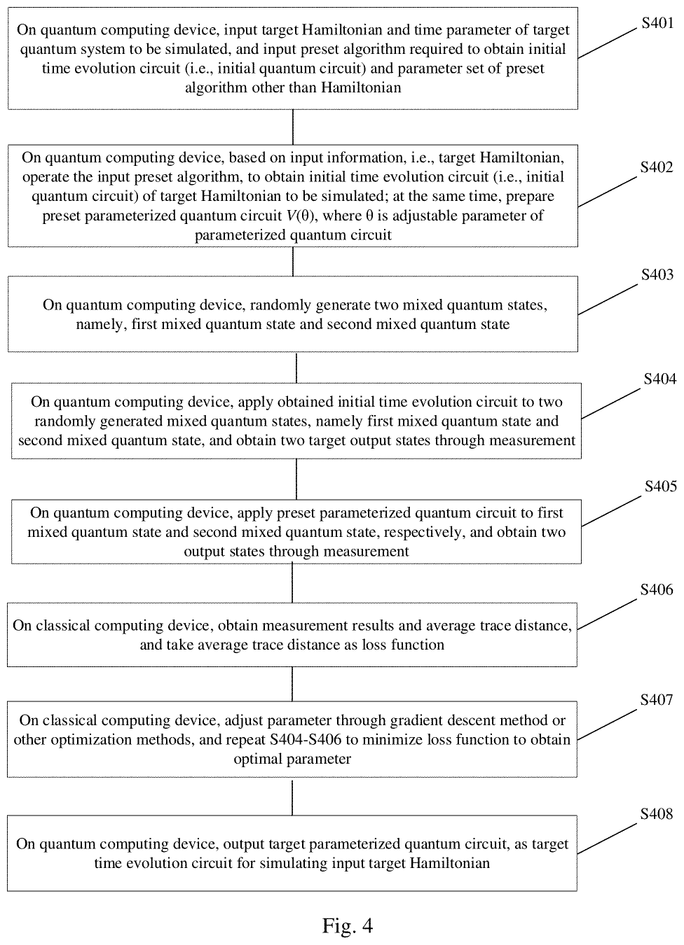

It should be noted that the scheme of the present disclosure may be operated both on the quantum computing device and the classical computing device. In the following, an efficiency maximization processing method will be given, and the simulation process will be completed based on a quantum-classical hybrid algorithm. As shown in FIG. 4, specific steps include the followings.

In S401, on a quantum computing device, inputting a target Hamiltonian H and a time parameter t of a target quantum system to be simulated, and inputting a preset algorithm F required to obtain an initial time evolution circuit (i.e., an initial quantum circuit) and a parameter set A of the preset algorithm F other than the Hamiltonian H and the time parameter t.

In S402, on the quantum computing device, operating the input preset algorithm F based on input information, i.e., the target Hamiltonian H, the time parameter t and the parameter set A, to obtain the initial time evolution circuit (i.e., the initial quantum circuit) of the target Hamiltonian H to be simulated, which is recorded as U; and at the same time, preparing a preset parameterized quantum circuit V(θ), where θ is an adjustable parameter of the parameterized quantum circuit, such as the preset parameterized quantum circuit shown in FIG. 2.

It can be understood that the processes of S401 and S402 may be simulated in a classical computer, but the computational cost is higher than in the quantum computing device.

In S403, on the quantum computing device, randomly generating two mixed quantum states, which are a first mixed quantum state ρ and a second mixed quantum state U.

In S404, on the quantum computing device, applying the obtained initial time evolution circuit U to the two randomly generated mixed quantum state, namely, the first mixed quantum state ρ and the second mixed quantum state σ, to obtain, through measurement, two target output states. In other words, the initial time evolution circuit U is applied to the first mixed quantum state ρ to obtain the first target output state UρU^{\} through measurement; and similarly, the initial time evolution circuit U is applied to the second mixed quantum state σ to obtain the second target output state UσU^{†} through measurement, where U^{†} represents a conjugate transpose of the initial time evolution circuit U.

In other words, in the example, two pairs of quantum states, namely {(ρ, UρU^{†}), (σ, UσU^{†})}, is a data set used for the example training.

In S405, on the quantum computing device, applying the preset parameterized quantum circuit V(θ) to the first mixed quantum state ρ and the second mixed quantum state u, respectively, to obtain two output states, which are a first output state V(θ)ρV(θ)^{†} and a second output state V(θ)σV(θ)^{†}.

In S406, on the classical computing device, obtaining measurement results, which are the first target output state UρU^{†}, the second target output state UσU^{†}, the first output state V(θ)ρV(θ)^{†} and the second output state V(θ)σV(θ)^{†} obtained through the measurement, obtaining an average trace distance based on a trace distance between the first output state V(θ)ρV(θ)^{†} and the first target output state UρU^{\} and a trace distance between the second output state V(θ)σV(θ)^{†} and the second target output state UσU^{†}, and taking the average trace distance as a loss function to obtain a loss value of the loss function, where the loss function is expressed as: Loss function

$$C ( θ ) = \frac{1}{2} ( T ( V ( θ ) ρ {V ( θ )}^{†} , U ρ {U}^{†} ) + T ( V ( θ ) σ {V ( θ )}^{†} , U σ {U}^{†} ) ) ,$$

where T(·,·) represents the trace distance between two quantum states used to obtain the loss value of the loss function.

In S407, on the classical computing device, adjusting a parameterθ through a gradient descent method or other optimization methods, repeating S404-S406 to minimize the loss function C(θ), and recording the obtained optimal parameter as θ*. The target parameterized quantum circuit V(θ*) corresponding to the optimal parameter θ* is the approximate quantum circuit of the initial time evolution circuit (i.e., the initial quantum circuit) U, which is the target time evolution circuit.

In S408, on the quantum computing device, outputting the target parameterized quantum circuit V(θ*), as the target time evolution circuit for simulating the inputted target Hamiltonian given by the scheme of the present disclosure.

It is worth noting that the scheme of the present disclosure adopts the quantum-classical hybrid algorithm to set the preset parameterized quantum circuit V(θ) on the quantum computer (i.e., the quantum computing device) and measure the trace distance between the corresponding output state (the first output state and the second output state) and the target output state (the first target output state and the second target output state), and to calculate the loss function C(θ) on the classical computer (i.e., the classical computing device), uses traditional optimization methods to optimize the parameter θ and then sends optimized θ back to the quantum computer to update the preset parameterized quantum circuit. As such, the training is completed.

It can be understood that, in the above specific scheme, it is necessary to input the Hamiltonian, the simulation time, the preset algorithm for generating the initial time evolution circuit, for example, to build the initial time evolution circuit. However, in practical application, if there is an ideal time evolution circuit of the quantum system to be simulated, at this time, the ideal time evolution circuit may be directly used as the initial time evolution circuit U without having to generate the initial time evolution circuit.

Thus, the present disclosure has the following advantages.

The scheme of the present disclosure is more flexible and practical. Compared with the existing simulation scheme of the product method (the cost of the simulated quantum circuit is relatively high due to the underlying mathematical principle), the scheme of the present disclosure is completely free from the limitation of the product method, and may flexibly select appropriate quantum gates to build a preset parameterized quantum circuit according to specific application scenarios and the characteristics of hardware devices, and may train the preset parameterized quantum circuit to easily extract the characteristics of the Hamiltonian of a specific quantum system, so that the quantity of quantum gates used can be greatly reduced while keeping the simulation accuracy unchanged. Therefore, the scheme of the present disclosure is more suitable for state-of-the-art quantum computing devices with a limited quantity of quantum bits and susceptible to noise, and has both universality and practicality.

The scheme of the present disclosure can realize quantum simulation without auxiliary quantum bits, is suitable for realizing quantum simulation on state-of-the-art quantum computing devices, and has high efficiency.

The advantages of the scheme of the present disclosure will be further shown below in combination with specific cases; specifically, in this example, the one-dimensional and annular Heisenberg model is selected as the quantum system to be simulated. Heisenberg model is a commonly used model in physics, and its Hamiltonian may be written as follows: H=Σₖ₌₁hₖσₖ^{z}+Σₖ₌₁ⁿσₖ^{x}σₖ₊₁^{x}+Σₖ₌₁ⁿσₖ^{y}σₖ₊₁^{y}+Σₖ₌₁ⁿσₖ^{z}σₖ₊₁^{z}, where n represents the quantity of quantum bits in the quantum system, σₖ^{x}, σₖ^{y}, σₖ^{z} represent Pauli matrices on the kth qubit, respectively, and hₖ represents a coefficient related to the environmental magnetic field. Because the quantum system has a ring structure, the (n+1)th qubit represents the first qubit. In the specific numerical experiment, n=3 is selected in this example which is a Heisenberg model having three qubits, and a magnetic field coefficient hₖ is randomly generated within the range of [−1,1].

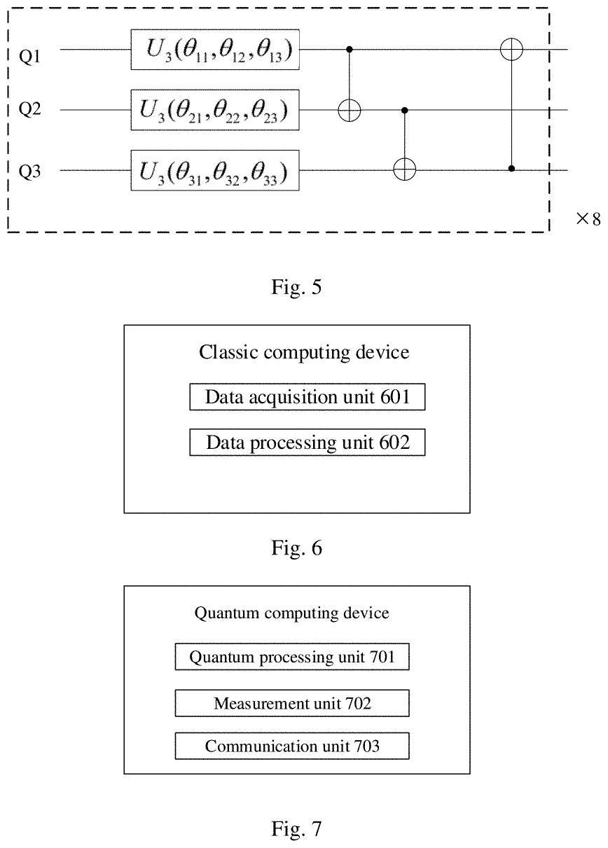

Firstly, an initial time evolution circuit U is constructed based on the second-order trot-Suzuki product (i.e., the preset algorithm described above), which contains 4,320 quantum gates. At the same time, a preset parameterized quantum circuit V(θ) with only 48 quantum gates is prepared, the structure of each layer (8 layers in total) of which is shown in FIG. 5.

Secondly, the preset parameterized quantum circuit V(θ) as constructed is trained based on the method described in the present disclosure, and after 300 rounds of iterative training, a trained target parameterized quantum circuit V(θ*) is obtained, a gate fidelity of which reaches 0.9999 with respect to the initial time evolution circuit U. In such a manner, it can be fully illustrated that the scheme of the present disclosure can greatly reduce the simulation cost on the premise of ensuring the simulation accuracy.

A scheme of the present disclosure further provides a classical computing device, as shown in FIG. 6, including: a data acquisition unit 601, configured to acquire at least two measurement results, where a first measurement result of the at least two measurement results represents a trace distance between a first output state and a first target output state; a second measurement result of the at least two measurement results represents a trace distance between a second output state and a second target output state; the first output state is an output state after a preset parameterized quantum circuit acts on a first quantum state in the case where an adjustable parameter of the preset parameterized quantum circuit is at a first parameter value; the second output state is an output state after the preset parameterized quantum circuit acts on a second quantum state in the case where the adjustable parameter of the preset parameterized quantum circuit is at the first parameter value; the first target output state represents an output state after an initial time evolution circuit acts on the first quantum state; the second target output state represents an output state after the initial time evolution circuit acts on the second quantum state; the initial time evolution circuit is an approximate quantum circuit of a unitary matrix of a target quantum system containing n quantum bits; the preset parameterized quantum circuit is a quantum circuit containing n quantum bits and having the adjustable parameter; and n is a natural a quantity greater than or equal to 1; and a data processing unit 602, configured to calculate a loss value of a loss function representing an average trace distance, based on trace distances represented by the at least two measurement results; and take the preset parameterized quantum circuit with the adjustable parameter at the first parameter value as a target parameterized quantum circuit, in the case where the loss value of the loss function satisfies an iteration requirement, where the target parameterized quantum circuit is the approximate quantum circuit of the initial time evolution circuit.

In this way, the scheme of the present disclosure simplifies the approximate quantum circuit of the unitary matrix of the target quantum system and designs a quantum circuit having a relatively high simulation accuracy on the short-term and medium-term quantum computing device, thereby greatly reducing the cost of quantum simulation on the state-of-the-art quantum computing devices and improving the possibility of realizing practical quantum simulation applications on the state-of-the-art quantum devices with both practicality and efficiency.

In a specific example according to the present disclosure, a quantity of quantum gates in the preset parameterized quantum circuit is less than a quantity of quantum gates in the initial time evolution circuit.

In a specific example according to the present disclosure, the data acquisition unit is further configured to obtain the initial time evolution circuit of the target quantum system.

In a specific example according to the present disclosure, the data acquisition unit is further configured to obtain at least a target Hamiltonian and a time parameter of the target quantum system to be simulated; and the data processing unit is further configured to process the target Hamiltonian and the time parameter of the target quantum system based on a preset algorithm, to obtain the initial time evolution circuit that simulates the unitary matrix of the target quantum system and contains at least the time parameter.

In a specific example according to the present disclosure, the data acquisition unit is further configured to acquire the preset algorithm and a parameter set of the preset algorithm; and the data processing unit is further configured to operate the preset algorithm, based on the target Hamiltonian, the time parameter and the parameter set, to obtain the initial time evolution circuit that simulates the unitary matrix of the target quantum system and contains at least the time parameter.

In a specific example according to the present disclosure, the first quantum state and the second quantum state satisfies the following requirement: in the case where the first quantum state ρ satisfies V(θ) ρ V^{†} (θ)=UρU^{†} and the second quantum state σ satisfies V(θ) σ V^{\} (θ)=UσU^{†}, U^{†} V(θ)=I is obtained, where U is the initial time evolution circuit, V(θ) is the preset parameterized quantum circuit, and θ is the adjustable parameter.

In a specific example according to the present disclosure, the first quantum state is a mixed quantum state; and/or the second quantum state is a mixed quantum state.

In a specific example according to the present disclosure, the data processing unit is further configured to adjust the first parameter value of the adjustable parameter to a second parameter value, in the case where the loss value of the loss function does not satisfies the iteration requirement, and send the second parameter value of the adjustable parameter.

In a specific example according to the present disclosure, the data acquisition unit is further configured to acquire at least two new measurement results, where a new first measurement result of the at least two new measurement results represents a new trace distance between a new first output state and the first target output state; a new second measurement result of the at least two new measurement results represents a new trace distance between s new second output state and the second target output state; the new first output state is an output state after the preset parameterized quantum circuit acts on the first quantum state in the case where its own adjustable parameter is at the second parameter value; the new second output state is an output state after the preset parameterized quantum circuit acts on the second quantum state in the case where its own adjustable parameter is at the second parameter value; and the data processing unit is further configured to calculate a new loss value of the loss function, based on new trace distances represented by the at least two new measurement results, until the new loss value satisfies the iteration requirement.

For the specific function of each unit in the above classical computing equipment, reference can be made to the above method, which will not be repeated herein.

In this way, the scheme of the present disclosure simplifies the approximate quantum circuit of the unitary matrix of the target quantum system and designs a quantum circuit having a relatively high simulation accuracy on the short-term and medium-term quantum computing devices, thereby greatly reducing the cost of quantum simulation on the state-of-the-art quantum computing devices and improving the possibility of realizing practical quantum simulation applications on the state-of-the-art quantum devices with both practicality and efficiency.

A scheme of the present disclosure further provides a quantum computing device, as shown in FIG. 7, including: a quantum processing unit 701 configured to apply a preset parameterized quantum circuit to at least a first quantum state to obtain a first output state in the case where an adjustable parameter of the preset parameterized quantum circuit is at a first parameter value; and apply the preset parameterized quantum circuit to at least a second quantum state to obtain a second output state in the case where the adjustable parameter of the preset parameterized quantum circuit is at the first parameter value; a measurement unit 702 configured to acquire at least two measurement results, where a first measurement result of the at least two measurement results represents a trace distance between the first output state and a first target output state; a second measurement result of the at least two measurement results represents a trace distance between the second output state and a second target output state; the first target output state represents an output state after an initial time evolution circuit acts on the first quantum state; the second target output state represents an output state after the initial time evolution circuit acts on the second quantum state; the initial time evolution circuit is an approximate quantum circuit of a unitary matrix of a target quantum system containing n quantum bits; the preset parameterized quantum circuit is a quantum circuit containing n quantum bits and having the adjustable parameter; and n is a natural number greater than or equal to 1; and a communication unit 703 configured to send the at least two measurement results.

In a specific example according to the present disclosure, a quantity of quantum gates in the preset parameterized quantum circuit is less than a quantity of quantum gates in the initial time evolution circuit.

In a specific example according to the present disclosure, the quantum processing unit is further configured to obtain the initial time evolution circuit of the target quantum system.

In a specific example according to the present disclosure, the quantum processing unit is further configured to obtain at least a target Hamiltonian and a time parameter of the target quantum system to be simulated; and process the target Hamiltonian and the time parameter of the target quantum system based on a preset algorithm, to obtain the initial time evolution circuit that simulates the unitary matrix of the target quantum system and contains at least the time parameter.

In a specific example according to the present disclosure, the quantum processing unit is further configured to acquire the preset algorithm and a parameter set of the preset algorithm; and to operate the preset algorithm, based on the target Hamiltonian, the time parameter and the parameter set, to obtain the initial time evolution circuit that simulates the unitary matrix of the target quantum system and contains at least time parameter.

In a specific example according to the present disclosure, the first quantum state and the second quantum state satisfy the following requirement: in the case where the first quantum state ρ satisfies V(θ) ρ V^{\} (θ)=UρU^{\} and the second quantum state σ satisfies V(θ) σ V^{\} (θ)=UσU^{†}, (U^{†} V(θ)=I is obtained, where U is the initial time evolution circuit, V(θ) is the preset parameterized quantum circuit, and θ is the adjustable parameter.

In a specific example according to the present disclosure, the first quantum state is a mixed quantum state; and/or the second quantum state is a mixed quantum state.

In a specific example according to the present disclosure, the quantum processing unit is further configured to apply the initial time evolution circuit to the first quantum state, to obtain the first target output state; and apply the initial time evolution circuit to the second quantum state, to obtain the second target output state.

In a specific example according to the present disclosure, the quantum processing unit is further configured to receive a second parameter value of the adjustable parameter; to apply the preset parameterized quantum circuit to at least the first quantum state to obtain a new first output state in the case where its own adjustable parameter is at the second parameter value, and to apply the preset parameterized quantum circuit to at least the second quantum state to obtain a new second output state in the case where its own adjustable parameter is at the second parameter value.

The measurement unit is further configured to acquire at least two new measurement results, where a new first measurement result of the at least two new measurement results represents a new trace distance between a new first output state and the first target output state; a new second measurement result of the at least two new measurement results represents a new trace distance between a new second output state and the second target output state.

The communication unit is further configured to send the at least two new measurement results.

For the specific functions of each unit in the above quantum computing device, reference can be made to the above method, which will not be repeated herein.

In this way, the scheme of the present disclosure, by using two quantum states at a minimum, such as the first quantum state and the second quantum state, can simplify the initial time evolution circuit, reduce the resource cost and time cost of quantum simulation, greatly improve the practicality of quantum simulation, provide technical support for the state-of-the-art quantum devices to operate complex quantum algorithms, and indirectly improve a value of the practical application of the state-of-the-art quantum devices.

In the meanwhile, the scheme of the present disclosure simplifies the approximate quantum circuit of the unitary matrix of the target quantum system and designs a quantum circuit having a relatively high simulation accuracy on the short-term and medium-term quantum computing devices, thereby greatly reducing the cost of quantum simulation on the state-of-the-art quantum computing devices and improving the possibility of realizing practical quantum simulation applications on the state-of-the-art quantum devices with both practicality and efficiency.

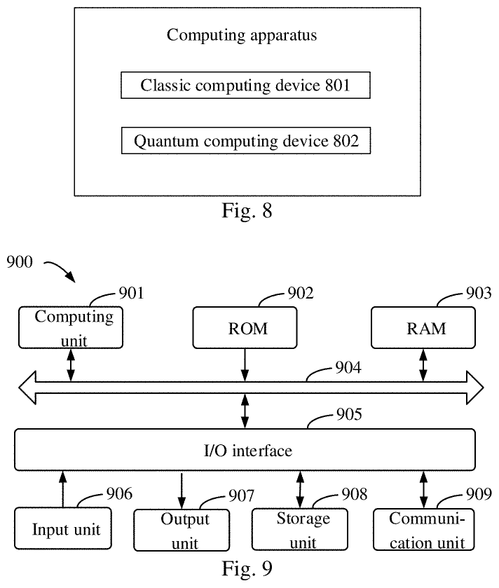

A scheme of the present disclosure further provides a computing apparatus, as shown in FIG. 8, including: the classic computing device 801 as described above, and the quantum computing device 802 as described above.

For the specific structure of the above classical computing device and the specific functions of each unit in the classical computing device, reference can be made to the above method. Similarly, for the specific structure of the above quantum computing device and the specific functions of each unit in the quantum computing device, reference can be made to the above method, the description of which will not be repeated herein.

A scheme of the present disclosure further provides a non-transitory computer-readable storage medium storing a computer instruction. When executed by at least one quantum processing unit, the computer instruction causes the at least one quantum processing unit to execute the above method applied to the quantum computing device.

A scheme of the present disclosure further provides a computer program product including a computer program. The computer program, when executed by a processor, implements the above method applied to the classical computing device; alternatively, the computer program, when executed by at least one quantum processing unit, implements the method applied to the quantum computing device.

A scheme of the present disclosure further provides a quantum computing device, which includes: at least one quantum processing unit (QPU); and a memory coupled to the at least one QPU and configured to store an executable instruction, where the instruction is executed by the at least one quantum processing unit to enable the at least one quantum processing unit to execute the method applied to the quantum computing device.

It can be understood that the quantum processing unit (QPU) used in the scheme of the present disclosure may also be called a quantum processor or a quantum chip, and may involve a physical chip including a plurality of quantum bits interconnected in a specific way.

Moreover, it can be understood that the quantum bit described in the scheme of the present disclosure can refer to a basic information unit of a quantum computing device. The quantum bits are included in QPU, and the concept of classical digital bits is extended.

According to an embodiment of the present disclosure, the present disclosure further provides a classical computing device (which is described below by way of an electronic apparatus as an example), a readable storage medium, and a computer program product.

According to an embodiment of the present disclosure, the present disclosure further provides an electronic apparatus, a readable storage medium and a computer program product.

FIG. 9 shows a block diagram of an example electronic apparatus 900 that may be used to implement embodiments of the present disclosure. The electronic apparatus is intended to represent various forms of digital computers, such as a laptop, a desktop, a workstation, a personal digital assistant, a server, a blade server, a mainframe computer, and other suitable computers. The electronic apparatus may also represent various forms of mobile devices, such as a personal digital processing, a cellular phone, a smart phone, a wearable device and other similar computing devices. The components shown herein, their connections and relationships, and their functions are merely examples, and are not intended to limit the implementation of the present disclosure described and/or required herein.

As shown in FIG. 9, the apparatus 900 includes a computing unit 901 which may perform an appropriate action and appropriate processing based on a computer program stored in a Read Only Memory (ROM) 902 or a computer program loaded into a Random Access Memory (RAM) 903 from a storage unit 908. Various programs and data required for operations of apparatus 900 may also be stored in the RAM 903. The computing unit 901, the ROM 902 and the RAM 903 are connected to each other through a bus 904. An input/output (I/O) interface 905 is also connected to the bus 904.

The plurality of components connected to the I/O interface 905 in the apparatus 900 includes an input unit 906 such as a keyboard, a mouse, or the like; an output unit 907 such as various types of displays, speakers, or the like; the storage unit 908 such as a magnetic disk, an optical disk, or the like; and a communication unit 909 such as a network card, a modem, a wireless communication transceiver, or the like. The communication unit 909 allows the apparatus 900 to exchange information/data with other devices through a computer network such as the Internet and/or various telecommunication networks.

The computing unit 901 may be various general-purpose and/or special-purpose processing components with processing and computing capabilities. Some examples of the computing unit 901 include, but are not limited to, a Central Processing Unit (CPU), a Graphics Processing Unit (GPU), various dedicated Artificial Intelligence (AI) computing chips, various computing units running machine learning model algorithms, a Digital Signal Processor (DSP), and any appropriate processors, controllers, microcontrollers, or the like. The computing unit 901 performs various methods and processes described above, such as a simulation method of a quantum system applied to a classical computing device. For example, in some implementations, the simulation method of the quantum system applied to the classical computing device may be implemented as a computer software program, which is tangibly contained in a machine-readable medium, such as the storage unit 908. In some implementations, a part or all of the computer program may be loaded and/or installed on the apparatus 900 via the ROM 902 and/or the communication unit 909. When the computer program is loaded into the RAM 903 and executed by the computing unit 901, one or more steps of the simulation method of the quantum system applied to the classical computing device as described above may be performed. Alternatively, in other implementations, the computing unit 901 may be configured to perform the simulation method of the quantum system applied to the classical computing device by any other suitable means (e.g., by means of firmware).

Various implements of the system and technologies described above herein may be implemented in a digital electronic circuit system, an integrated circuit system, a Field Programmable Gate Array (FPGA), an Application Specific Integrated Circuit (ASIC), a Special Standard Product (ASSP), a System-on-Chip (SOC), a Load Programmable Logic Device (CPLD), a computer hardware, firmware, software, and/or a combination thereof. These various implementations may include an implementation in one or more computer programs that may be executed and/or interpreted on a programmable system including at least one programmable processor, and the programmable processor may be a special-purpose or general-purpose programmable processor, may receive data and an instruction from a storage system, at least one input device and at least one output device, and may transmit the data and the instruction to the storage system, the at least one input device and the at least one output device.

Program codes for implementing the methods of the present disclosure may be written in any combination of one or more programming languages. These program codes may be provided to a processor or a controller of a general-purpose computer, a special-purpose computer or other programmable data processing devices, such that the program codes, when executed by the processor or the controller, cause the functions/operations specified in the flowcharts and/or block diagrams to be implemented. The program codes may be completely executed on a machine, partially executed on the machine, partially executed on the machine as a separate software package and partially executed on a remote machine, or completely executed on the remote machine or a server.

In the context of the present disclosure, the machine-readable medium may be a tangible medium, which may contain or store a program for use by or in connection with an instruction execution system, a device or an apparatus. The machine-readable medium may include, but is not limited to, an electronic medium, a magnetic medium, an optical medium, an electromagnetic medium, an infrared medium, or a semiconductor system, a semiconductor device, or a semiconductor apparatus, or any suitable combination of thereof. More specific examples of the machine-readable storage medium may include electrical connections based on one or more lines, a portable computer disk, a hard disk, a Random Access Memory (RAM), a Read Only Memory (ROM), an Erasable Programmable Read Only Memory (EPROM or a flash memory)), optical fiber, a portable Compact Disk Read Only Memory (CD-ROM), an optical storage device, a magnetic storage device, or any suitable combination of thereof.

In order to provide interaction with a user, the system and techniques described herein may be implemented on a computer. The computer has a display device (e.g., a Cathode Ray Tube (CRT) or a Liquid Crystal Display (LCD) monitor) for displaying information to the user, and a keyboard and a pointing device (e.g., a mouse or a trackball). The user may provide input to the computer through the keyboard and the pointing device. Other kinds of devices may also be used to provide interaction with user. For example, feedback provided to the user may be any form of sensory feedback (e.g., visual feedback, auditory feedback, or tactile feedback), and the input from the user may be received in any form (including an acoustic input, a voice input, or a tactile input).

The system and techniques described herein may be implemented in a computing system including a background component (e.g., as a data server), or a computing system including a middleware component (e.g., an application server), or a computing system including a front-end component (e.g., a user computer with a graphical user interface or a web browser, in which the user may interact with the implement of the system and technologies described herein through the graphical user interface or the web browser), or in a computing system including any combination of the background component, the middleware component, or the front-end component. The components of the system may be interconnected by digital data communication (e.g., a communication network) in any form or medium. Examples of the communication network include a Local Area Network (LAN), a Wide Area Network (WAN), and Internet.

A computer system may include a client and a server. The client and the server are generally far away from each other and usually interact with each other through a communication network. A relationship between the client and the server arises by a computer program running on a corresponding computer and having a client-server relationship with each other. The server may be a cloud server, a server of a distributed system, or a server combined with a block chain.

It should be understood that, the steps may be reordered, added or removed by using the various forms of the flows described above. For example, the steps recorded in the present disclosure can be performed in parallel sequentially or in different orders, as long as a desired result of the technical scheme disclosed in the present disclosure may be realized, which is not limited herein.

The above specific embodiments do not constitute restrictions on the scope of protection of the present disclosure. Those skilled in the art should understand that various modifications, combinations, sub-combinations and substitutions can be made according to design requirements and other factors. Any modification, equivalent and improvement made within the spirit and principles of this disclosure shall be included in the scope of protection of this disclosure.

What is claimed is:

1. A simulation method of a quantum system, applied to a classical computing device, comprising:
acquiring at least two measurement results, wherein a first measurement result of the at least two measurement results represents a trace distance between a first output state and a first target output state; a second measurement result of the at least two measurement results represents a trace distance between a second output state and a second target output state; the first output state is an output state after a preset parameterized quantum circuit acts on a first quantum state in a case of an adjustable parameter of the preset parameterized quantum circuit is at a first parameter value; the second output state is an output state after the preset parameterized quantum circuit acts on a second quantum state in a case of the adjustable parameter of the preset parameterized quantum circuit is at the first parameter value; the first target output state represents an output state after an initial time evolution circuit acts on the first quantum state; the second target output state represents an output state after the initial time evolution circuit acts on the second quantum state; the initial time evolution circuit is an approximate quantum circuit of a unitary matrix of a target quantum system containing n quantum bits; the preset parameterized quantum circuit is a quantum circuit containing n quantum bits and having the adjustable parameter; and n is a natural number greater than or equal to 1;
calculating a loss value of a loss function representing an average trace distance, based on trace distances represented by the at least two measurement results; and
taking the preset parameterized quantum circuit with the adjustable parameter at the first parameter value as a target parameterized quantum circuit, in a case of the loss value of the loss function satisfies an iteration requirement, wherein the target parameterized quantum circuit is the approximate quantum circuit of the initial time evolution circuit.

2. The method of claim 1, wherein a quantity of quantum gates in the preset parameterized quantum circuit is less than a quantity of quantum gates in the initial time evolution circuit.

3. The method of claim 1, further comprising:
obtaining the initial time evolution circuit of the target quantum system.

4. The method of claim 1, further comprising:
obtaining at least a target Hamiltonian and a time parameter of the target quantum system to be simulated; and
processing the target Hamiltonian and the time parameter of the target quantum system based on a preset algorithm, to obtain the initial time evolution circuit that simulates the unitary matrix of the target quantum system and contains at least the time parameter.

5. The method of claim 4, further comprising:
acquiring the preset algorithm and a parameter set of the preset algorithm,
wherein processing the target Hamiltonian and the time parameter of the target quantum system based on the preset algorithm to obtain the initial time evolution circuit that simulates the unitary matrix of the target quantum system and contains at least the time parameter, comprises:
operating the preset algorithm, based on the target Hamiltonian, the time parameter and the parameter set, to obtain the initial time evolution circuit that simulates the unitary matrix of the target quantum system and contains at least the time parameter.

6. The method of claim 1, wherein the first quantum state and the second quantum state satisfy the following requirement:
in a case of the first quantum state ρ satisfies V(θ) ρ V^{\} (θ)=UρU^{\} and the second quantum state σ satisfies V(θ) σ V^{\} (θ)=UσU^{†}, U^{†} V(θ)=I is obtained,
wherein U is the initial time evolution circuit, V(θ) is the preset parameterized quantum circuit, and θ is the adjustable parameter.

7. The method of claim 1, wherein the first quantum state is a mixed quantum state; and/or
the second quantum state is a mixed quantum state.

8. The method of claim 1, further comprising:
adjusting the first parameter value of the adjustable parameter to a second parameter value, in a case of the loss value of the loss function does not satisfy the iteration requirement; and
sending the second parameter value of the adjustable parameter;
wherein the method further comprises:
acquiring at least two new measurement results, wherein a new first measurement result of the at least two new measurement results represents a new trace distance between a new first output state and the first target output state; a new second measurement result of the at least two new measurement results represents a new trace distance between a new second output state and the second target output state; the new first output state is an output state after the preset parameterized quantum circuit acts on the first quantum state in a case of the adjustable parameter of the preset parameterized quantum circuit is at the second parameter value; and the new second output state is an output state after the preset parameterized quantum circuit acts on the second quantum state in a case of the adjustable parameter of the preset parameterized quantum circuit is at the second parameter value; and
calculating a new loss value of the loss function, based on new trace distances represented by the at least two new measurement results, until the new loss value satisfies the iteration requirement.

9. A simulation method of a quantum system, applied to a quantum computing device, comprising:
applying a preset parameterized quantum circuit to at least a first quantum state to obtain a first output state in a case of an adjustable parameter of the preset parameterized quantum circuit is at a first parameter value, and applying the preset parameterized quantum circuit to at least a second quantum state to obtain a second output state in a case of the adjustable parameter of the preset parameterized quantum circuit is at the first parameter value;
acquiring at least two measurement results, wherein a first measurement result of the at least two measurement results represents a trace distance between the first output state and a first target output state; a second measurement result of the at least two measurement results represents a trace distance between the second output state and a second target output state; the first target output state represents an output state after an initial time evolution circuit acts on the first quantum state; the second target output state represents an output state after the initial time evolution circuit acts on the second quantum state; the initial time evolution circuit is an approximate quantum circuit of a unitary matrix of a target quantum system containing n quantum bits; the preset parameterized quantum circuit is a quantum circuit containing n quantum bits and having the adjustable parameter; and n is a natural number greater than or equal to 1; and
sending the at least two measurement results.

10. The method of claim 9, wherein a quantity of quantum gates in the preset parameterized quantum circuit is less than a quantity of quantum gates in the initial time evolution circuit.

11. The method of claim 9, further comprising:
obtaining the initial time evolution circuit of the target quantum system.

12. The method of claim 9, further comprising:
obtaining at least a target Hamiltonian and a time parameter of the target quantum system to be simulated; and
processing the target Hamiltonian and the time parameter of the target quantum system based on a preset algorithm, to obtain the initial time evolution circuit that simulates the unitary matrix of the target quantum system and contains at least the time parameter.

13. The method of claim 12, further comprising:
acquiring the preset algorithm and a parameter set of the preset algorithm,
wherein processing the target Hamiltonian and the time parameter of the target quantum system based on the preset algorithm to obtain the initial time evolution circuit that simulates the unitary matrix of the target quantum system and contains at least the time parameter, comprises:
operating the preset algorithm, based on the target Hamiltonian, the time parameter and the parameter set, to obtain the initial time evolution circuit that simulates the unitary matrix of the target quantum system and contains at least the time parameter.

14. The method of claim 9, wherein the first quantum state and the second quantum state satisfy the following requirement:
in a case of the first quantum state ρ satisfies V(θ) ρ V^{\} (θ)=UρU^{\} and the second quantum state a satisfies V(θ) u V^{\} (θ)=UσU^{†}, U^{†} V(θ)=I is obtained,
wherein U is the initial time evolution circuit, V(θ) is the preset parameterized quantum circuit, and θ is the adjustable parameter.

15. The method of claim 9, wherein the first quantum state is a mixed quantum state; and/or the second quantum state is a mixed quantum state.

16. The method of claim 9, further comprising:
applying the initial time evolution circuit to the first quantum state, to obtain the first target output state; and applying the initial time evolution circuit to the second quantum state, to obtain the second target output state;
wherein the method further comprises:
receiving a second parameter value of the adjustable parameter;
applying the preset parameterized quantum circuit to at least the first quantum state to obtain a new first output state, in a case of the adjustable parameter is at the second parameter value, and applying the preset parameterized quantum circuit to at least the second quantum state to obtain a new second output state, in a case of the adjustable parameter is at the second parameter value;
acquiring at least two new measurement results; wherein a new first measurement result of the at least two new measurement results represents a new trace distance between a new first output state and the first target output state; and a new second measurement result of the at least two new measurement results represents a new trace distance between a new second output state and the second target output state; and
sending the at least two new measurement results.

17. A classical computing device, comprising:
at least one processor; and
a memory connected in communication with the at least one processor,
wherein the memory stores an instruction executable by the at least one processor, and the instruction, when executed by the at least one processor, enables the at least one processor to execute the method of claim 1.

18. A quantum computing device, comprising:
at least one quantum processing unit (QPU); and
a memory coupled to the at least one QPU and configured to store an executable instruction,
wherein the instruction is executed by the at least one quantum processing unit to enable the at least one quantum processing unit to execute the method of claim 9.

19. A non-transitory computer-readable storage medium on which a computer instruction is stored, wherein the computer instruction is used to cause a computer to execute the method of claim 1.

20. A non-transitory computer-readable storage medium on which a computer instruction is stored, wherein the computer instruction, when executed by at least one quantum processing unit, causes the at least one quantum processing unit to execute the method of claim 9.
